(19) United States
(12) Patent Application Publication
(10) Pub. No.: US 2010/0081532 A1
(43) Pub. Date: Apr. 1, 2010

(54) Drive tumbler

(75) Inventors: Michael V. McCafferty, Pekin, IL (US); John Whitelock, Chagrin Falls, OH (US); Scott Kreger, DuBois, IL (US); Troy Miller, Pekin, IL (US)

Correspondence Address: FLSMIDTH, 2040 Avenue C, Bethlehem, PA, 18017, US

(73) Assignee: Excel Foundry and Machine, Inc., Pekin, IL (US)

(21) Appl. No.: 12/586,260

(22) Filed: Sep. 18, 2009

Related U.S. Application Data
(60) Provisional application No. 61/192,566, filed on Sep. 19, 2008.

(51) Int. Cl. F16H 55/30; F16H 55/12

(52) U.S. Cl. 474/162

(57) ABSTRACT

A drive tumbler comprises a hub having attached thereto a plurality of replaceable rim segments. The rim segments are supported by a plurality of raised blocks that are formed integral with the hub and serve to absorb the shear forces to which the tumbler is subject during operation.

### CROSS REFERENCE TO RELATED APPLICATION

The present application claims priority to U.S. Provisional Patent Application No. 61/192,566, which was filed on Sep. 19, 2008.

### FIELD OF THE INVENTION

The present invention relates to pad drive type heavy equipment wherein a drive pad is engaged with a driven tumbler to induce relative motion. Even more particularly the present invention relates to the construction and repair of such tumblers in such equipment which has the advantage in that segments are removable while the hub is attached to the drive shaft. The invention is an improvement over prior art equipment in which the drive shaft is typically removed from the machine in order to replace or repair the drive tumbler in that the tumbler is designed to withstand the shear forces to which such equipment is subject.

### BACKGROUND OF THE INVENTION

Many types of heavy machinery—such as certain types used in mining operations—utilize driven tracks which carry a plurality of drive members on their inner surface. These members are engaged by the drive tumbler of the machine to induce relative motion between the pad and the machine. Examples of this type of track driven machinery include an electric rope shovel and a hydraulic excavator/shovel. Typically in such equipment it is less expensive and time-consuming to replace the drive tumblers than to replace the pad. Therefore, the drive members on the tracks may be made to not wear as quickly as the drive tumblers, that is, they have a wear characteristic greater than the wear characteristic of the drive tumblers. Accordingly, it is advantageous to utilize drive tumblers designed to reduce the effort and time required to repair worn surfaces on the tumblers.

### SUMMARY OF THE INVENTION

It is the object of the present invention to provide a construction for a drive tumbler which will enable the tumbler to be rapidly and easily repaired. It is a further object of the present invention to provide a segmented drive tumbler that can sufficiently withstand shear forces.

The present invention addresses the above and other objects by having a drive tumbler having replaceable rim segments and a means of absorbing the shear forces to which the tumbler is subject during operation.

### DESCRIPTION OF THE DRAWINGS

The foregoing and additional features are described in the following detailed specification, which is accompanied by drawings in which:

FIG. 1 is a side view of the assembled segmented drive tumbler of the present invention,

FIG. 2 is a sectional view taken along line 2-2 of FIG. 1.

FIG. 3 is a perspective view of the assembled segmented drive tumbler of the present invention.

FIG. 4 is a perspective view of the hub of the drive tumbler of the present invention without the attached segments.

FIG. 5 is a perspective view of the track engagement side of a replaceable segment of the present invention.

FIG. 6 is a side perspective view of the hub engagement side of a replaceable segment of the present invention.

FIGS. 7 and 8 are perspective views of the drive tumbler of the invention shown in combination with a drive track in various stages of uncoupling.

FIGS. 9 and 10 are perspective views of drive tumbler of the invention shown in combination with a drive track, with different views of one displaced segment.

FIG. 11 is a side elevation in cross section of a drive track drive pad used in conjunction with the present invention.

FIG. 12 is a view taken along line 3-3 of FIG. 11, and shows a sectional view of a track pad.

### DETAILED DESCRIPTION OF THE INVENTION

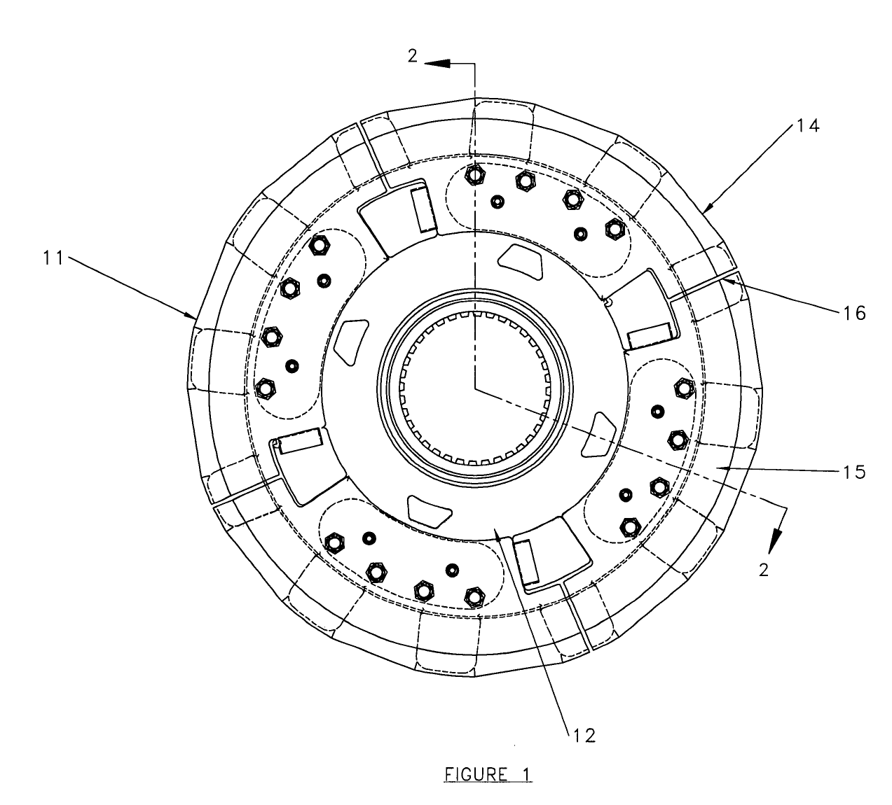

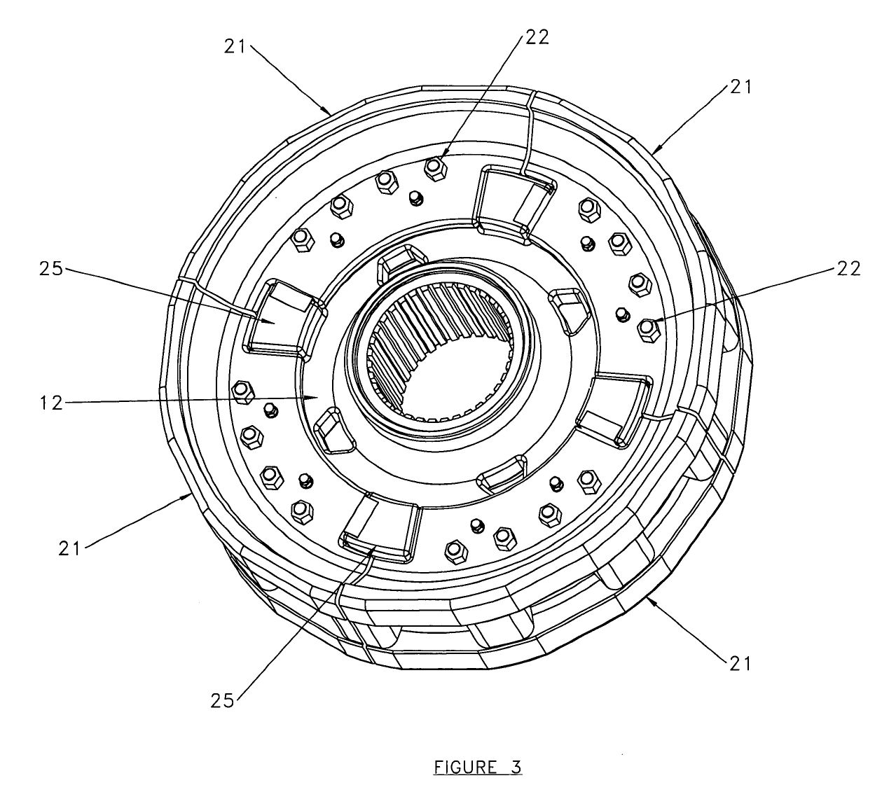

Referring to FIGS. 1 and 3, there is shown an essentially circular drive tumbler 11 of the present invention. Drive tumbler 11 includes an internally radially extending hub 12, which is splined for mounting on its driving shaft (not shown). Drive tumbler 11 also includes outer circular rim 14, consisting of multiple removable segments, which rim has formed therein a plurality of spaced apart openings 15 which receive therewithin the drive members (lugs) affixed to an associated drive track. A plurality, in this case four, of selectively removable segments 21 (the number of segments being determined by the practitioner of the invention) are displaced around the periphery of hub 12 to form in combination an outer rim 14. Segments 21 are supported by raised blocks 25, which are formed integral with as a permanent part of the hub and project from the radial plane of hub 12. By being integral with the hub, blocks 25 serve to carry the forces acting on the drive tumbler, including the weight of the machine being driven. In the depicted example each block 25 is disposed between and supports the ends of adjacent segments 21, although blocks 25 may be situated in other locations wherever there is contact between the segments and the hub so long as they continue to support segments 21. Furthermore, while in the depicted examples drive tumbler 11 has an equal number of blocks 25 and segments 21, this is not necessary for every embodiment of the invention. Releasable means 22, which can for example be nuts and bolts, serve to secure the attachment of segments 21 to hub 12. It should be noted that the releasable means 22 are not intended to handle the shear forces acting upon the drive tumbler, since without the benefit of the supporting blocks the releasable means 22 can be subject to be stripped from the drive tumbler by the shear forces acting on the drive tumbler. In addition, segments 21 typically remain independent from each other when acting in combination to form the outer rim and consequently circumferential force is not transferred from one segment to the next adjacent segment by compression. In the present invention there preferably is a designed break or gap 16 between adjacent segments 21 (preferably between about 3 mm and about 13 mm) for ease of installation and removal of the segments and which further allows the segments to remain independent of each other while in operation. Blocks 21 can be of varied radial cross-sectional shapes, including but not limited to square, rectangular, rhomboidal, rhombus, triangular, circular and oval.

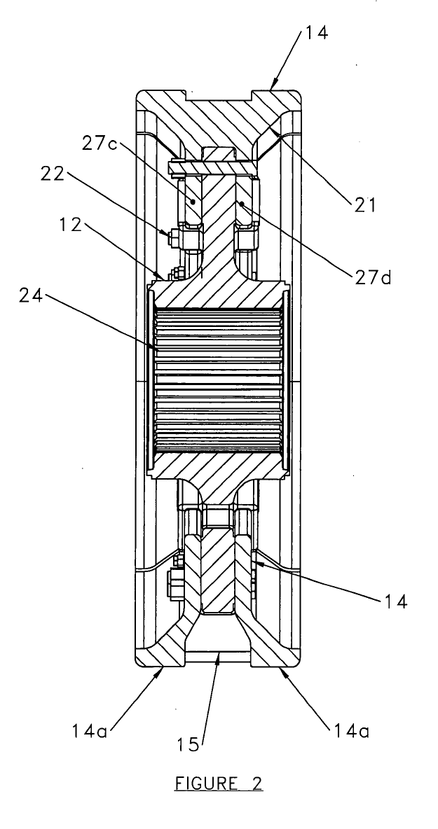

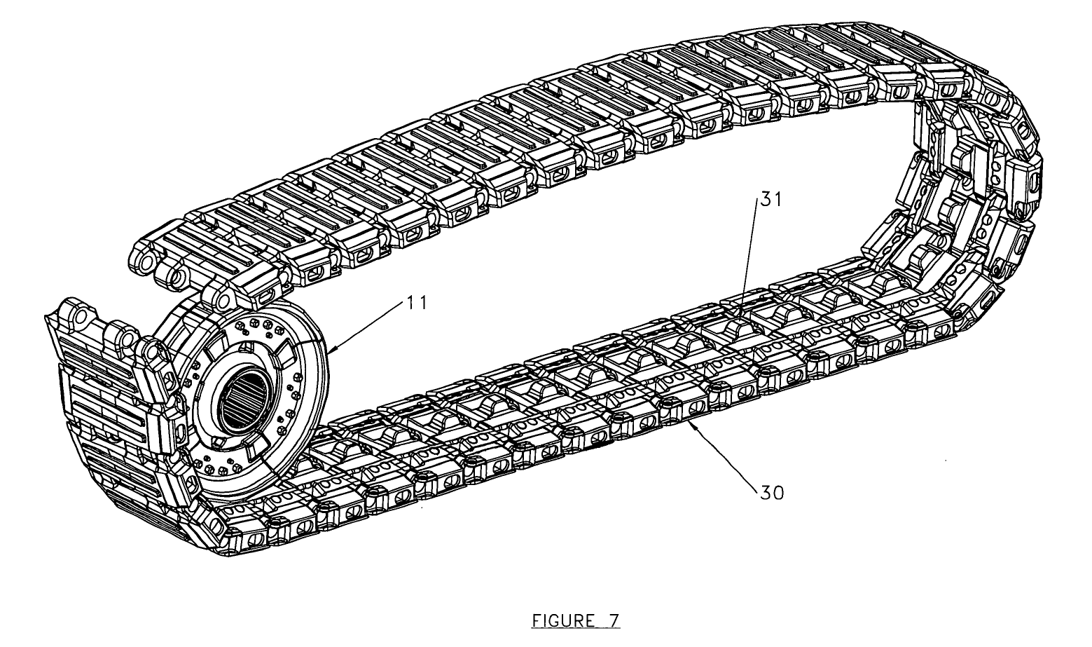

FIG. 2 depicts hub splines 24. In the figure hub 12 is shown to closely fit within a groove formed between opposing radially extending sides 27c and 27d of segment 21. Alternatively, hub 12 and segment 21 may connect by other means. Thereafter hub 12 and segment 21 are securely fastened to each other by releasable fastening means 22. Outer rim 14 has contact areas 14a which contact an associated drive track (30 in FIG. 7) and an opening 15 which receive associated drive members (31 in FIG. 7). Segments 21 will be designed to have a wear characteristic less than the wear characteristic of the drive members.

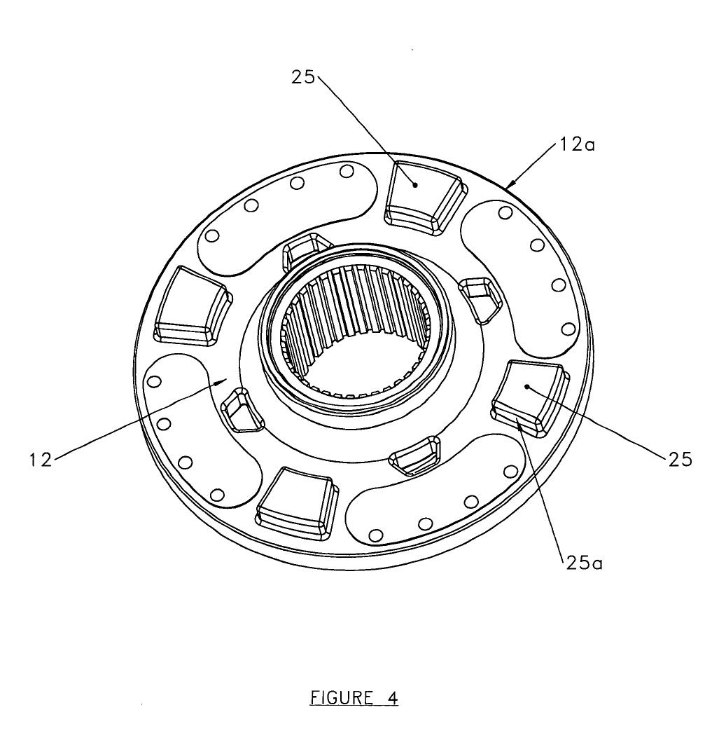

As depicted in FIG. 4 raised blocks 25 have sides 25a which project out from each radial surface of the hub 12. Blocks 25 serve to absorb the shear forces acting upon the drive tumbler. A shim kit may be employed to adjust the lateral forces and down forces acting on the raised blocks. In addition, a raised block 25 may be machined along with one of the segments for aligning the segments in “time” to the splines on the hub. This may be used in conjunction with a gauge to assure that the distance, i.e. the spacing, between each drive segment is consistent to the proper pitch of the track pads of track pad driven machinery.

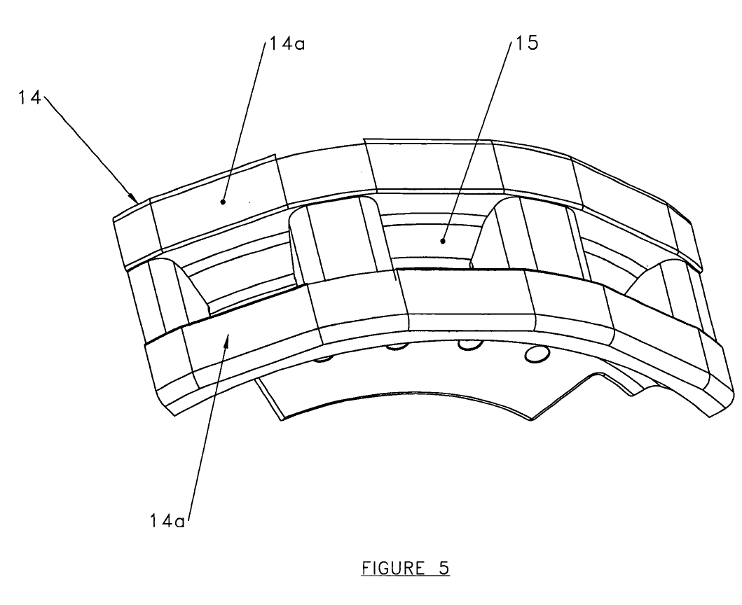

FIG. 5 shows outer rim portion 14 of segment 21 in which there are deployed openings 15 which are engagable with and disposed to rotatably move the drive members of an associated drive track.

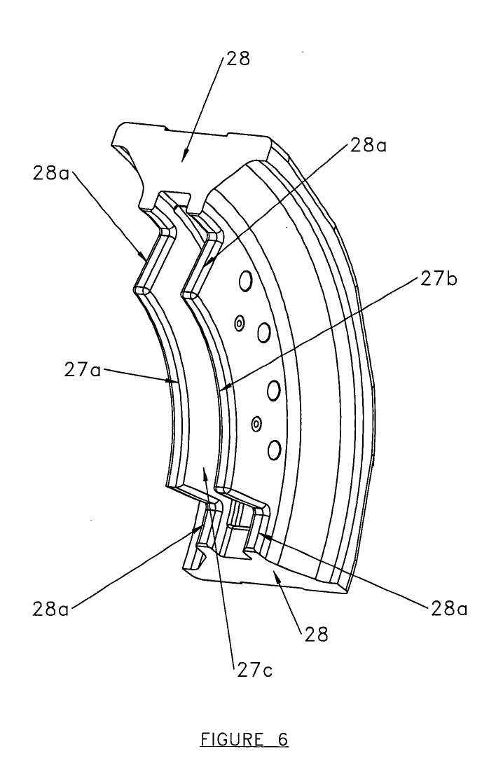

FIG. 6 depicts inner side of segment 21, including inner radially extending sides 27a and 27b which are spaced apart to form a slot 27c sized to closely accept the insertion therein of the outer peripheral surface 12a (FIG. 4) of hub 12. Each edge 28 of segment 21 has a corresponding cut away portion 28a which is sized and shaped to supportably mate with a side portion 25a of block 25. Outer peripheral surface 12, each side 27a and 27b and outer rim 14 all have the same curvature.

In FIGS. 7-10 the drive shaft is not depicted for simplicity of illustration but it is understood that in all cases the drive tumbler can preferably remain attached to its associated drive shaft when the depicted operations are performed.

FIG. 7 depicts drive tumbler 11 in conjunction with endless drive track 30. Endless drive track 30 is in a first disconnected state in preparation for replacing one of the segments 21. The drive track 30 includes a series of drive members 31 sized to engage openings 15 as drive tumbler 11 passes over drive track 30.

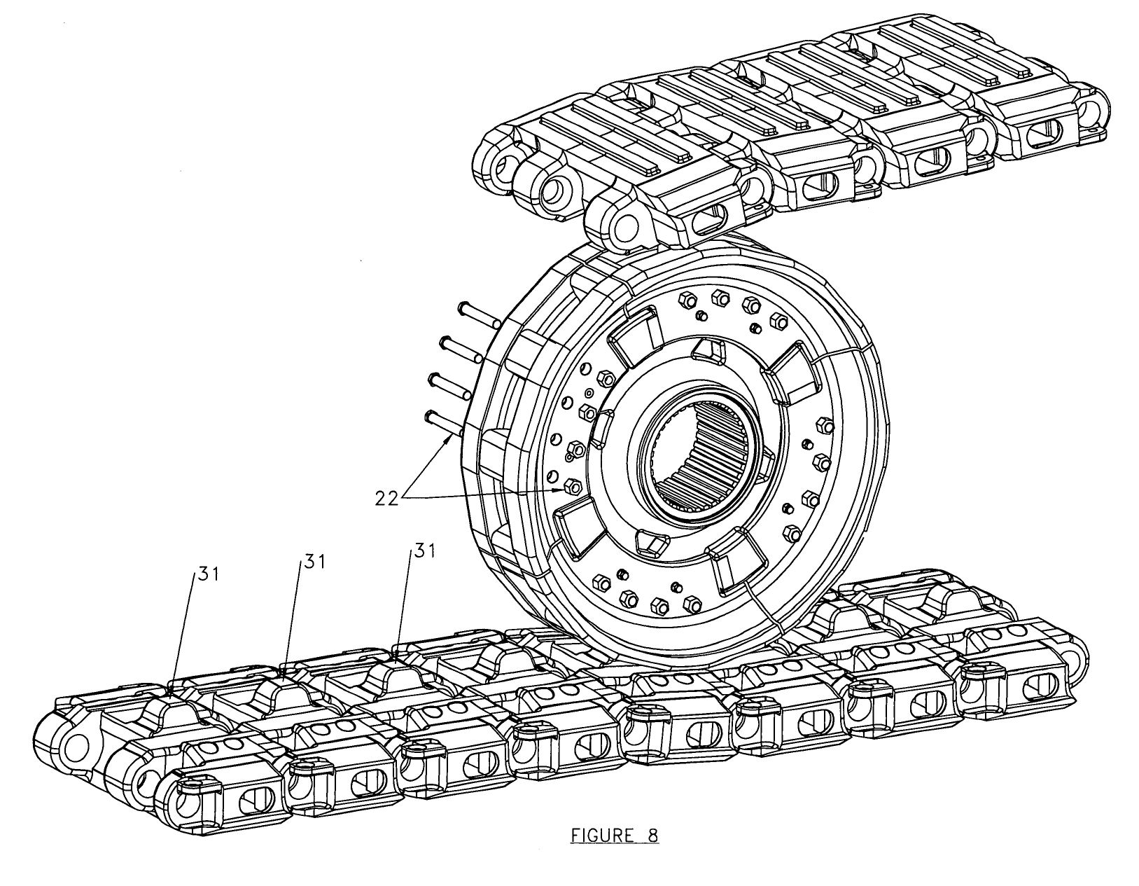

FIG. 8 depicts drive track 30 being further removed from tumbler 11, with the connecting nuts and bolts 22 securing one segment in place having been removed.

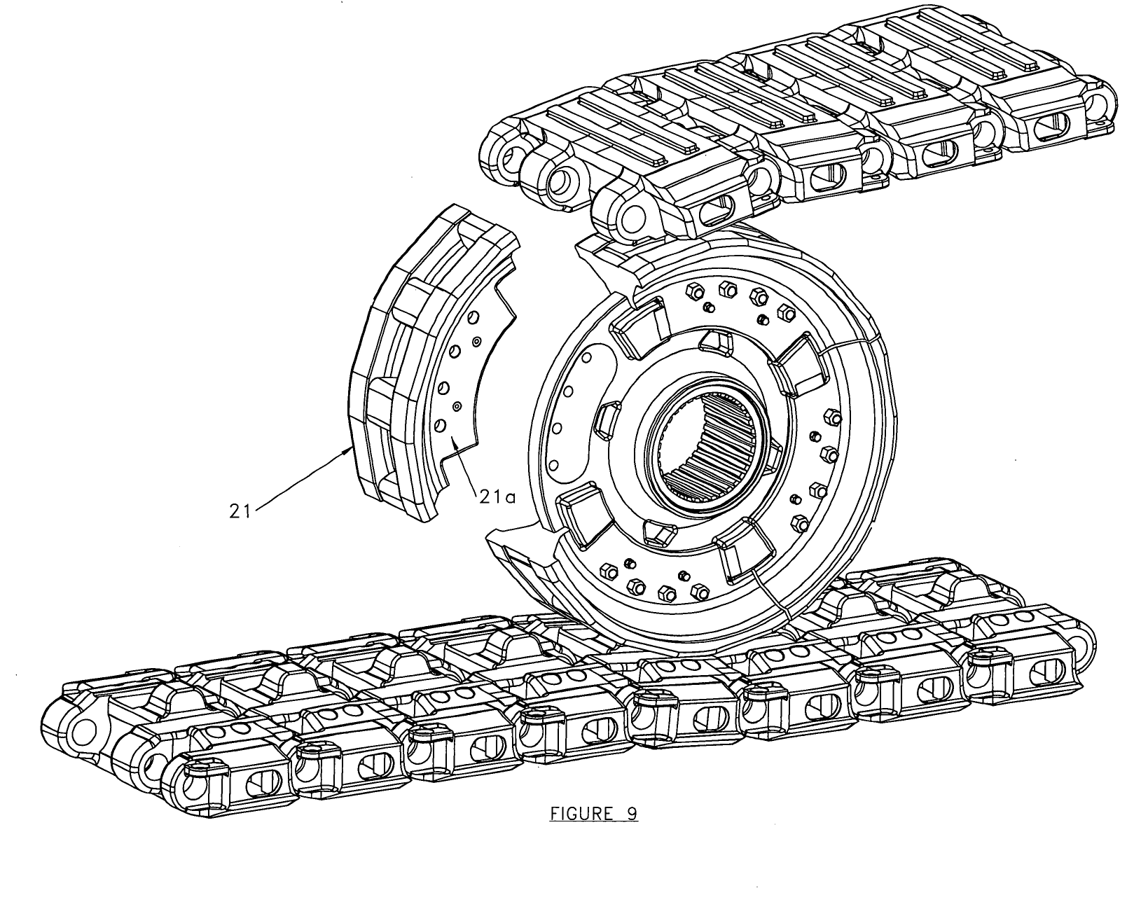

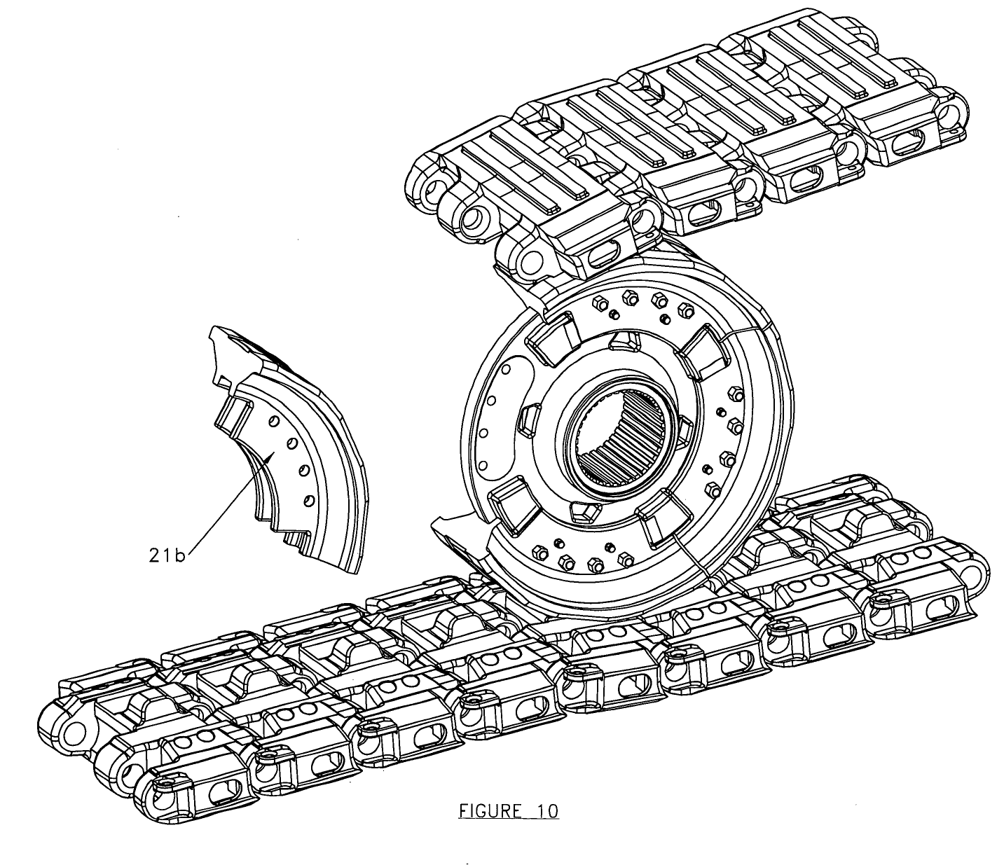

In FIG. 9 segment 21 is removed from the radially outermost portion, i.e. the periphery, 12a of hub 12 and depicts side 21a of segment 21. In FIG. 10 the removed segment is rotated from the view shown in FIG. 9 to depict opposite and identical side 21b of segment 21.

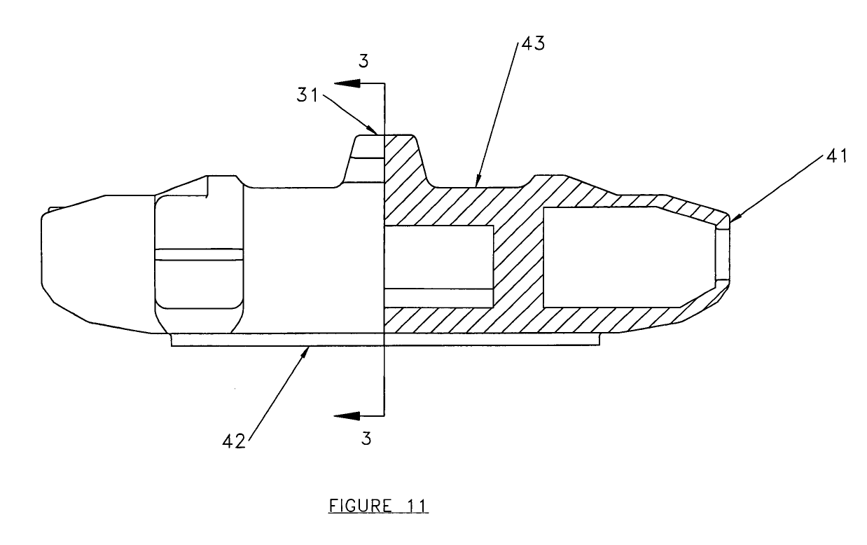

FIG. 11 depicts drive track pad 41, which comprises in part drive lug 31, ground contact area 42 and outer rim contact area 43.

As an example of the wear of the components to a drive tumbler system, during the life of the drive track group the track pad pin pitch is extended lengthening the track. As indicated, the drive tumbler is designed to engage the track for propulsion. As the track and the drive tumbler wear the pin pitch lengthens and the engagement between the track and the drive tumbler become out of time. At this point the initial drive tumbler segments will be replaced with over-pitched segments which will extend the life of the drive tumblers and the track groups, with the goal being that the replaceable segments will maintain proper pin pitch over the life of the track.

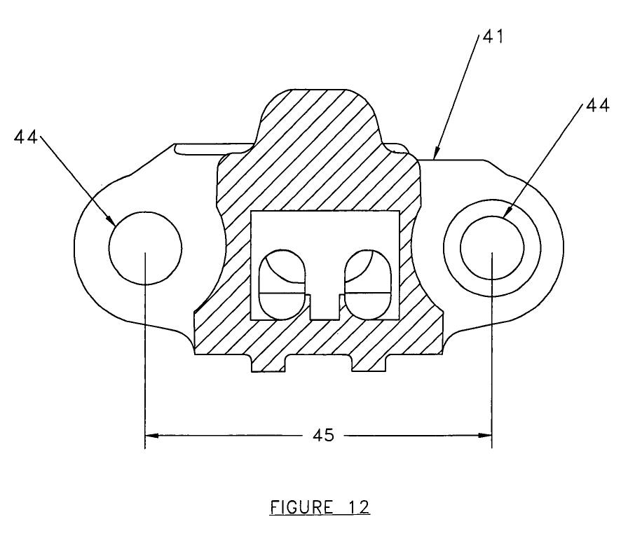

As depicted in FIG. 12 the pitch 45 is the distance between the center of pin eyes 44 on front and back on the track pads. Over the life of the pads this distance grows as the result of one or more of the wear of the pin eyes, wear of the track pin and/or elongation. As this “stretch” occurs the track pad becomes longer while the outer diameter of the drive tumbler is becoming smaller. When this occurs the drive lugs on the track pads do not properly make contact with the drive tumbler, with the result that the drive tumbler becomes “out of pitch” requiring an over pitch drive tumbler which consists of the drive contact area on the drive tumbler being positioned slightly further apart.

As indicated above, since there is a significantly greater cost ratio of the track pad group to the drive tumbler, which at the time of the current application is approximately 10:1, it is more cost effective to repair or replace the drive tumbler. Typically the track pads are only repaired in the event of a broken connecting pin that connects adjacent track pads or a cracked pad.

The track group and segmented drive tumbler are thus designed in conjunction to achieve an extended targeted life reducing downtime and improving equipment availability.

The invention having been thus described it will be obvious that the same may be varied in many ways without departing from the spirit and scope thereof. All such modifications are included within the scope of the invention which is defined by the following claims.

We claim:

1. A drive tumbler for moving a drive track comprising,
a radially extending hub having an outer circular periphery;
a plurality of selectively removable segments, each segment attachable to the periphery to form in combination a circular outer rim to the drive tumbler, with said outer rim having defined therein a plurality of openings sized to receive drive pads associated with said drive track, and wherein said segments are supported by a plurality of blocks that are formed integral with and are raised above the radial plane of the hub.

2. The drive tumbler of claim 1 further comprising means for selectively securing and detaching each of said segments to said hub.

3. The drive tumbler of claim 2 wherein the securing and detaching means are nuts and bolts.

4. The drive tumbler of claim 1 wherein the outer periphery of the hub is insertable within a groove formed between opposing radially extending sides of a segment.

5. The drive tumbler of claim 1 wherein said segments have a wear characteristic less than the wear characteristic of said drive pads.

6. The drive tumbler of claim 1 wherein there is a gap between adjacent segments on the outer rim.

7. The drive tumbler of claim 1 wherein the blocks have a square radial cross-sectional shape.

8. The drive tumbler of claim 1 wherein the blocks have a rhomboidal radial cross-sectional shape.

9. The drive tumbler of claim 1 wherein there is an equal number of blocks and segments.

10. The drive tumbler of claim 9 wherein each block is disposed between and supports adjacent segments on the outer rim.
